(19) United States
(12) Patent Application Publication
(10) Pub. No.: US 2009/0272695 A1
(43) Pub. Date: Nov. 5, 2009

(54) Desalination with production of brine fuel

(76) Inventor: Benjamin Elias Blumenthal, Waterloo (BE)

Correspondence Address: Benjamin Blumenthal, Avenue Vert Bocage, 11, Waterloo, 1410, BE

(21) Appl. No.: 12/387,738

(22) Filed: May 8, 2009

Related U.S. Application Data
(63) Continuation-in-part of application No. 12/011,229, filed on Jan. 25, 2008.

(51) Int. Cl. C02F 1/58

(52) U.S. Cl. 210/747; 210/170.11

(57) ABSTRACT

The present invention involves a water-based vessel for the production of desalinated water and concentrated brine. The former is usable for drinking water in areas that lack sufficient potable water, while the latter may be used in part as fuel in electricity production. The invention additionally includes amphibious vehicles for the rapid and site-specific delivery and on-site production of potable water and electricity.

### BACKGROUND OF THE INVENTION

1. Field of the Invention

The present invention provides for a way of producing desalinated water in an environmentally-responsible and economically feasible manner. Specifically, unlike most desalination systems which discharge concentrated salt water back into the water source, usually the ocean, the present invention makes use of concentrated “waste” brine for alternative uses including but not limited to electrical power-plant fuel. Additionally, amphibious vehicles are used in the production and distribution of desalinated water.

2. Description of the Related Art

Drinking water is a precious commodity. Throughout the world, drought, urban overexpansion and lack of rain have contributed to significant shortages of drinkable water. Cities such as Atlanta and countries such as Israel have watched as their natural water resources have diminished dramatically in light of high demand and modest precipitation. The United Nations World Health Organization (WHO) estimates that even under normal rainfall conditions, one billion people lack access to safe drinking water and expects that two out of every three people will be living with water shortages by 2025. There clearly is a need for reliable alternative sources of drinking water for both developed and underdeveloped countries.

As the Earth is 70% covered by water, the obvious solution would be to transform undrinkable seawater into potable water. Seawater “as is” is dangerous for consumption and large quantities can lead to serious health issues with changes in cellular osmotic pressure. Desalination, the process by which seawater is cleaned of its high salt content, is not a new concept. Desalination plants have been active in various parts of the world for fifty years and most naval and commercial ships have produced onboard drinking water through desalination since World War II. While there are more than 1,500 desalination plants in the world, desalinated water provides only a small fraction of the world's available fresh water supply. The question is why. There are several reasons.

(1) Desalinated water is not cheap. When one factors in the costs of building a facility, securing “beach-front” property near the seawater source and the energy required to drive reverse osmosis, distillation or other desalination processes, the cost of desalinated water is generally not competitive with water derived from lake or aquifer sources.

(2) Desalination is an environmentally-destructive process. Desalination generally leads to heating of both the product potable water as well as the waste brine. The latter is generally returned to the ocean. Hot brine can be devestating on sea flora and fauna. Returning brine in the general area of the intake pipes for a desalination plant can lead to more difficult and costly preparation of drinkable water due to the higher salt concentration in the source sea water.

(3) Desalination is generally a very local phenomenon. The location of a desalination plant defines the immediate reach of the final product drinking water due to the costs of piping such water long-distance. Alternative shipping or transport means are not economically feasible and as such desalination plants are very local in their contribution to totally available drinking water. This point was poignantly demonstrated when Israel signed a water purchase agreement with Turkey. Neither country could propose a cost-effective solution for transporting the inexpensive Turkish water to willing Israeli consumers.

One approach to overcome the issue of local production of drinking water has been to outfit a ship that could desalinate water and then send the clean drinking water to land for distribution. The advantages of a ship include flexibility in location as per need, responsiveness to disasters where drinking water is often one of the most urgent commodities, lower fixed costs due to an absence of ocean-front property for function, and stability in drinking water availability by adding to local resources as per specific demand and conditions. Though most sea-going vessels desalinatee water for internal consumption, to date, there has never been a fleet of ocean-going vessels dedicated to desalinated water delivery in addition to disaster relief and electric power delivery.

The concept of a “floating desalination plant” has been discussed for years. Lampe, et al. describe a system for converting a retired oil tanker as a platform for Preussag reverse osmosis (Desalination 114: 145-151 [1997]). Gordon, et al in U.S. Pat. No. 7,081,205 and Gordon in U.S. Pat. Nos. 7,306,724, 7,476,323 & 7,510,658 describe systems for delivering desalinated water from a floating vessel. In their system they process the residual brine (“concentrate”) by mixing it with seawater to cool it and reduce its salt concentration prior to return of treated brine to the ocean. While their efforts may reduce the damage caused by the waste brine, they still return over-concentrated salts to the ocean and their vessel must have a significant volume set aside for mixing the millions of gallons of brine with sea water prior to ejection.

One remedy for brine disposal is to keep it on board or deliver it to land. While brine returned to the ocean can lead to both heating of the ocean and local hyperconcentration of salts, transferring the brine, at least in part, to land avoids both of these problems. The highly concentrated brine that is a necessary byproduct in production of desalinated water by any method could be used in several ways:

1. In appropriate countries, it could be dried down, with the resulting salt being sold as food-grade seasalt.

2. In some areas, the brine could be used to form a salt lake, similar to the Great Salt Lake or the Dead Sea, both of which are extremely popular tourist attractions and revenue-generating bodies of water.

3. Most importantly, the highly concentrated byproduct brine may be used for fuel. Scientist and inventor John Kanzius has described the application of radio frequency (RF) waves to salt solutions, with the concomitant production of a flame that bums at 1500 degrees Centigrade (http://peswiki.com/index.php/Directory:John_Kanzius_Produces_Hydrogen_from_Salt_Water_Using_Radio_Waves). In the future, when Kanzius' technology becomes commercial, there will be a genuine need for highly concentrated salt water and the concentrated brine byproduct of desalination will be in great demand.

### SUMMARY OF INVENTION

The present invention provides for a floating desalination system that delivers drinking water via amphibious production and delivery vehicles. Waste brine may be used in part aboard the mother vessel for power production. Specifically, the invention includes a vessel, the vessel having the ability to deploy amphibious desalinated water production vehicles to shore with concomitant use of waste brine to power the vessel.

Herewith is described a system for providing desalinated water to shore including a vessel, the vessel having an intake pipe and being capable of producing desalinated water via amphibious delivery vehicles wherein a portion of the waste concentrated brine is used to generate electrical power aboard the vessel.

In one aspect of the system, the vessel is a ship.

In still another aspect of the system, the vessel is a fixed offshore structure.

In yet another aspect of the system, at least five percent (5%) of the concentrated brine produced on the vessel is used to power the vessel, with the rest of the brine being returned to the ocean by any means.

In a further aspect of the invention, the concentrated brine is used, at least in part, to generate electricity, a portion of which may be sent to shore.

In still a further aspect of the invention, the amphibious delivery vehicles may bring drinking water and electricity to one or a plurality of inland locations.

In another aspect of the invention, the desalinated water is delivered to a plurality of inland locations by a plurality of amphibious delivery vehicles.

In another aspect of the invention, the amphibious delivery vehicle can be repeatedly attached and detached from the desalination mother vessel.

In yet a further aspect of the invention, the vessel may transfer electricity via a transmission line or batteries associated with the amphibious delivery vehicles to inland locations.

In one further aspect of the invention, the amphibious delivery vehicles may be robotic without any personnel.

The invention also includes a method for producing desalinated water and concentrated brine and shipping both separately to shore, including the steps: providing a vessel, the vessel being capable of producing desalinated water and concentrated brine; transferring desalinated water directly to point of use either with a pipe or with amphibious delivery vehicles; using a portion of the concentrated brine to generate electricity on the vessel; sending the electricity to shore; and, returning remaining concentrated brine to the sea.

In one aspect of the method, the vessel is a ship.

In another aspect of the method, desalinated water produced by the vessel is further purified prior to delivery of water to an inland location.

In still another aspect of the method, electrical energy is produced by converting thermal solar electricity to an RF signal, the RF signal being applied to the concentrated brine. Such an application of RF signal may be performed either on the vessel or on land.

In yet another aspect of the method, application of the RF signal to concentrated brine leads to production of intense heat, the heat being used to heat water to high-temperature steam for powering of an electricity-generating turbine.

In still a different aspect of the method, electricity produced by applying an RF signal to the concentrated brine is shipped via a transmission line realized as a cable to a land-based electrical grid.

The invention also includes a system for producing electrical energy from desalination byproduct concentrated brine, including: a vessel, the vessel being capable of producing desalinated water and concentrated brine; and, a amphibious delivery vessel for transferring drinking water and the concentrated brine to a shore-based holding element as well as water purification of contaminated land-based water sources.

In one aspect of the system, the vessel is a fixed offshore structure.

In another aspect of the invention, the fixed offshore structure is in close proximity to a power plant.

In still another aspect of the invention, the system includes a source for RF signal.

### BRIEF DESCRIPTION OF THE DRAWINGS

FIG. 1 is a schematic summary of desalination and its products.

FIG. 2 is a schematic view of heat production resulting from an RF signal applied to a salt solution.

FIG. 3 is a schematic view of steam production through application of an RF signal to a salt solution.

FIG. 4 is a schematic view of a preferred embodiment of the present invention.

FIG. 5 is a schematic view of a preferred embodiment of the present invention in action.

FIG. 6 is a schematic view of a preferred embodiment of the present invention.

FIG. 7 is a schematic view of a preferred embodiment of the present invention.

FIG. 8 is a schematic view of a preferred embodiment of the present invention.

FIG. 9 is a schematic view of a preferred embodiment of the present invention.

### DESCRIPTION OF THE PREFERRED EMBODIMENT

In the following description, numerous specific details are set forth in order to provide a thorough understanding of the present invention. It will be apparent, however, to one skilled in the art that the present invention may be practiced without these specific details. In other instances alternative materials and physical arrangements from those described may be employed in the present invention. The unique aspect of the invention, independent of materials or specific embodiment, is the active use of “waste” concentrated brine from a sea-based desalination vessel as well as delivery of desalinated inland through amphibious vehicles. Concentrated brine today is generally discarded in the ocean by one means or another. In the present invention, the concentrated brine is used, at least in part, for the generation of electrical power based on a recent discovery concerning heat generated from brine as a result of applying an RF signal to said brine.

### Definitions

To better understand the invention described in the present invention, certain terms are defined. Most definitions follow the normal meaning of the terms as used in the respective arts. Other terms unique to the present invention are defined for their specific meaning

A “vessel” or “desalination vessel” refers to a solid element that can rest in water without sinking. Examples of vessels include but are not limited to boats, ships, barges, seaplanes, as well as fixed structures like oil-rigs, fixed desalination plants and water-purification facilities.

An “amphibious delivery vehicle” or “amphibious vehicle” is a ship or other seaworthy element that can reversibly attach to and detach from a desalination “mother” vessel. An amphibious vehicle is capable of producing and storing desalinated water and can successfully navigate on land or in any type of water (sea, river, brackish, etc.). An amphibious vehicle can take desalinated water and potentially electricity deep inland, away from the location of the mother desalination vessel. Additionally, an amphibious vehicle can deliver emergency food rations, tent shelters and blankets as well as purify contaminated land-based water sources if required, as was recently the case in New Orleans.

“Desalination” may have its normal meaning in the art. Desalination for the present invention may be performed by any method including but limited to reverse osmosis, distillation, centrifugation and evaporation/condensation. During desalination, drinking water is separated from sea water leaving behind seawater with an elevated salt concentration. “Concentrated brine” refers to the post-desalination residual seawater with increased salt concentration. Specifically, “concentrated brine” refers to the desalination product that is not drinkable due to its significantly heightened salt concentration. “Brine” and “seawater” have their normal meanings. “Brine” and “saltwater” are used interchangeably in the present invention.

“Pipe” and “pipeline” have their normal meaning. A pipe or pipeline according to the present invention may be made of any appropriate material including but not limited to polymers, plastic, stainless steel, concrete, rubber and glass. It may also be flexible and hose-like or rigid, free floating on the surface of water or submerged with concrete blocks on the sea floor.

“Transmission line” may have its normal meaning as intended in the electrical arts.

“Intake pipe” refers to a pipe or other element that allows for intake of seawater by a vessel, the seawater being subject to a desalination process on the vessel.

“Holding tank” also referred to as a “storage facility” refers to a shore-based structure into which one may deliver desalinated water from a desalination vessel. The holding tank is constructed with materials and in such a manner so as to hold the desalinated water without risk of contamination to the desalinated water or damage to the holding tank.

“RF” and “radio frequency” have their normal meaning in the physical arts.

“Holding element” also referred to as a “storage element” refers to a shore-based structure into which one may deliver concentrated brine from a desalination vessel. The holding element is constructed with materials and in such a manner so as to hold the concentrated brine without risk of damage to either the holding element or the concentrated brine. Polymers are particular preferred for the internal portion of a holding element.

“Power plant” refers to a facility that produces electricity. A power plant may be located on a vessel or on land. Coal-fired electricity power plants are a non-limiting example of a power plant. A power plant according to the present invention may generate electricity by any means.

“Close proximity” with respect to a holding element for concentrated brine relative to an electricity-generating power plant is less than 5 kilometers. “Portion” with respect to concentrated brine shipped to shore may be between 0.1% and 100% of concentrated brine produces during desalination. The actual portion of concentrated brine shipped to shore is determined based on specific needs for the concentrated brine.

“Solar energy” may have its normal meaning in the art and collecting solar energy and converting it to electricity may be performed in any manner, including but not limited to PV, thermal-solar, and parabolic/oil methods.

### Specific Embodiments

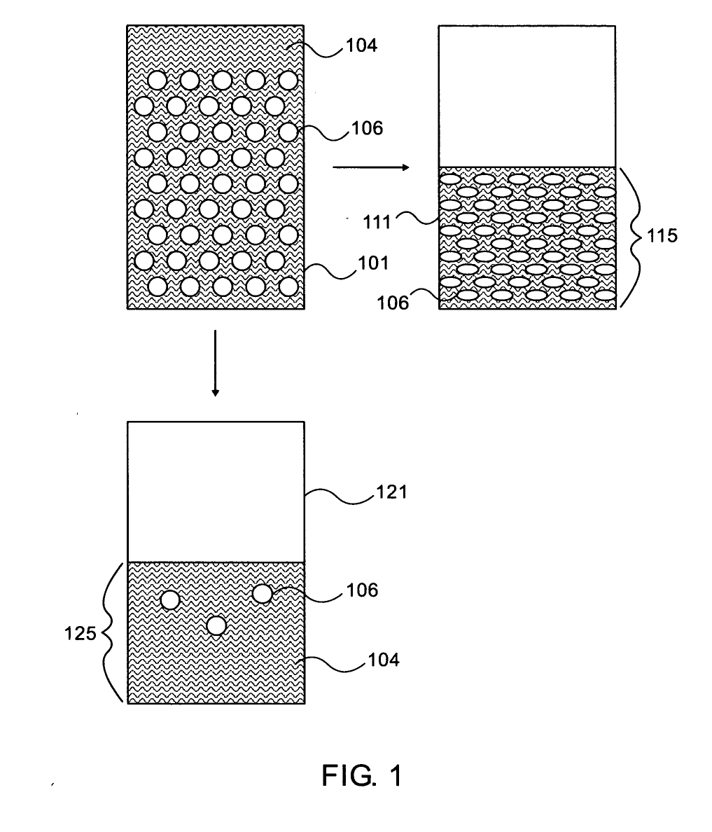

The invention described herewith has particular application for a desalination ship or sea-based structure. As noted in an embodiment below, the same method may be applied to a land-based desalination system as well. So as to clarify the substance of the present invention, attention is turned to FIG. 1. FIG. 1 shows a container (101) holding seawater. Seawater is represented by its two main components, namely water (104, waves), and ions (106, all ions, regardless of charge). Note that the components of seawater are not shown to scale and are shown in schematic form for ease of understanding of the invention only. All desalination processes, independent of specific methodology, produce two products, as additionally shown in FIG. 1. In container (111) is shown concentrated brine (115), the “waste” product of desalination. In the container (111) is water with a far-higher concentration of ions (106). This water is undrinkable, useless for agriculture, and if returned to the sea “as is” potentially dangerous to sea-based flora and fauna. Most desalination plants, both land- and sea-based, return the concentrated brine (115) in some form back to source sea. Return of concentrated brine (115) to the sea is deleterious to the well-being of ocean species and can make desalination more challenging as time passes due to a higher starting concentration of salt in seawater used for desalination.

In container (121) is product desalinated water (125). As shown, it contains primarily water (104) with very few remaining ions (106). The desalinated water (125) is appropriate for agricultural and human needs. The desalinated water (125) can be modified post-desalination by addition of other ions or vitamins (not shown). Alternatively or additionally, desalinated water (125) can be sterilized, filtered or otherwised purified post-desalination.

Until now, desalinated water has been of limited use primarily due to its cost. Much expense and inefficiency is associated with waste concentrated brine (115) due to its uselessness. In U.S. Pat. No. 7,081,205, Gordon, et al. go to great lengths to dilute and cool waste concentrated brine before return of brine to sea. Additionally, they use sophisticated systems to disperse the cooled and diluted waste brine prior to returning it back to the sea from which it was taken. Their brine disposal methods require large amounts of energy as well as valuable space on their desalination ship to accomplish their goals of diluting and returning waste brine. The space dedicated to diluting and cooling waste concentrated brine is space wasted from other valuable applications such as increased desalination capacity, battery storage of electricity generated by onboard solar and wind energy collection, and storage of ready-to-eat meals, emergency shelters and blankets for disaster victims. As such, the space is wasted with respect to potentially alternative applications.

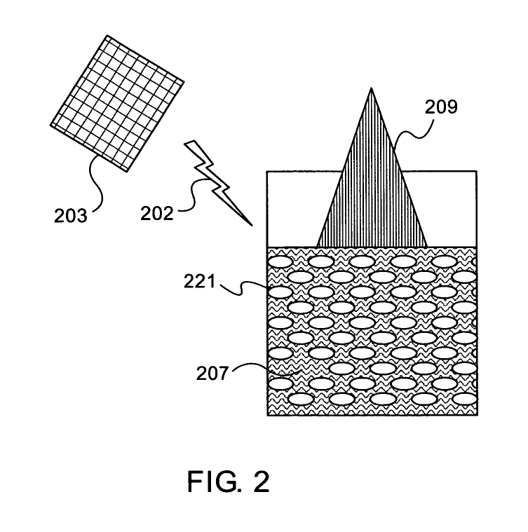

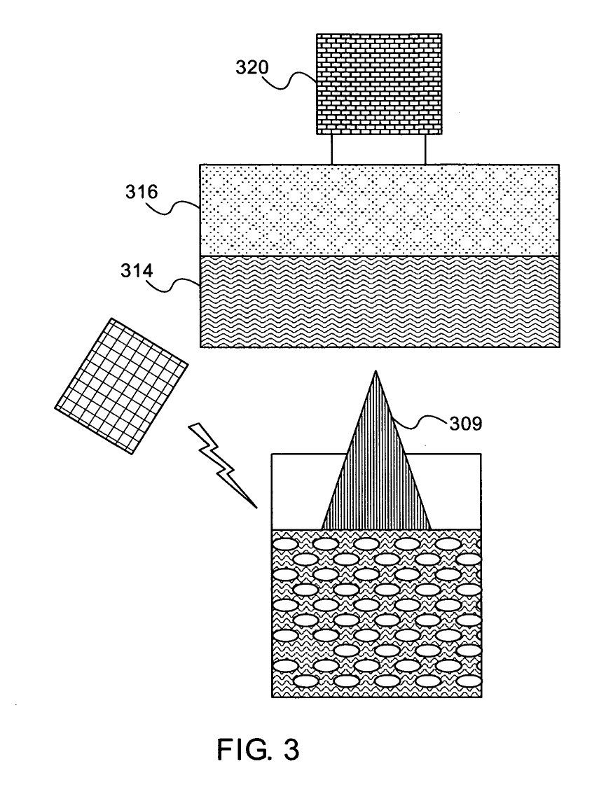

An invention by John Kanzius (Inventor on US Patent Application Numbers 20050251233; 20050251234; 20050273143; 20060190063; 20070250139) has provided the first hope for meaningful use of concentrated brine (115). Specifically, Kanzius has discovered that application of an RF signal (FIG. 2, 202) from an RF source (203) can cause saltwater (207) in a container (221) to produce a flame (209) of 1500 degrees Centigrade temperature (see reference above). According to Kanzius, the more concentrated the salt in solution, the more energy released (John Kanzius, personal communication). As shown in FIG. 3, flame (309) can heat water (314) to form high-temperature steam (316), the steam being capable of driving a turbine (320) for the production of electricity. Kanzius' discovery and the availability of concentrated brine as a byproduct of desalintion means that desalination may go beyond providing water to those in need. It may additionally lead to cheap electricity production via Kanzius' method of applying an RF signal to concentrated brine.

### First Embodiment

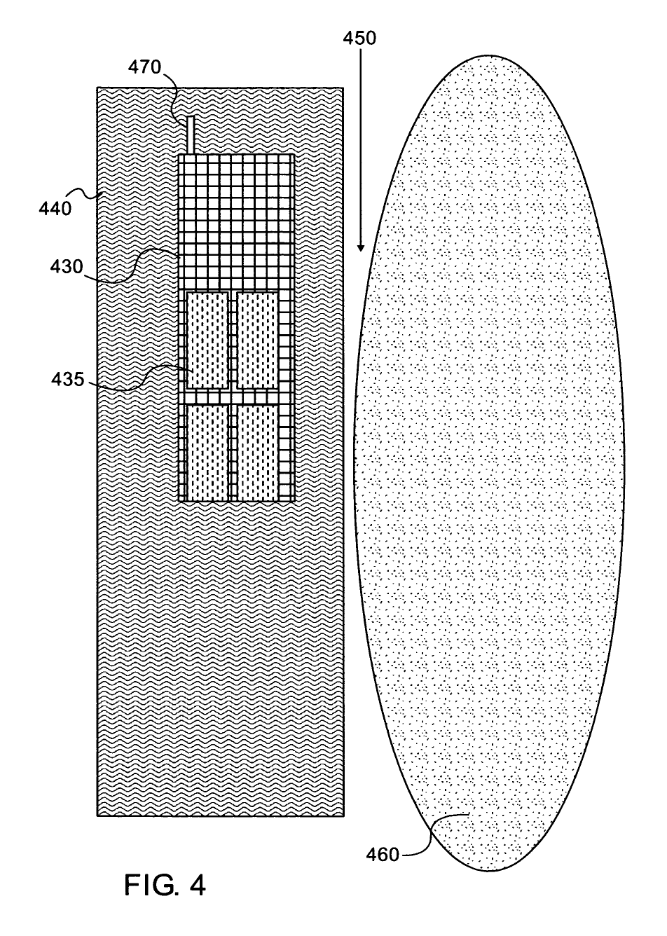

Attention is now drawn to FIG. 4 which shows a schematic view of a preferred embodiment according to the present invention. Specifically, vessel (430) is at sea (440) off the shore (450) of a land region (460). The vessel (430) is equipped with an intake pipe (470) that allows for intake of seawater into the vessel. The vessel (430) includes a plurality of amphibious vehicles (435) that can either perform desalination and/or receive desalinated water from the vessel. In the vessel (430), seawater from the intake pipe (470) is desalinated by any method of desalination including but not limited to reverse osmosis, distillation and evaporation/condensation (not shown). Desalination produces desalinated water and concentrated brine. Desalinated water may be stored on vessel (430) but is generally shipped by amphibious vehicles (435) to land region (460) or municipal water system (not shown) inland from the shore (450). Concentrated brine, in part, is used by the vessel (430) for production of electricity. Electricity is used by vessel (430) and may additionally be shipped to land region (460) through batteries (not shown) on the amphibious vehicles (435). The amount of concentrated brine used by vessel (430) will vary, with the remainder of the brine being shipped back into the sea. Generally, 5% or more of concentrated brine is used for electricity production. The remainder is dispersed in the sea (440) by any known dispersion means.

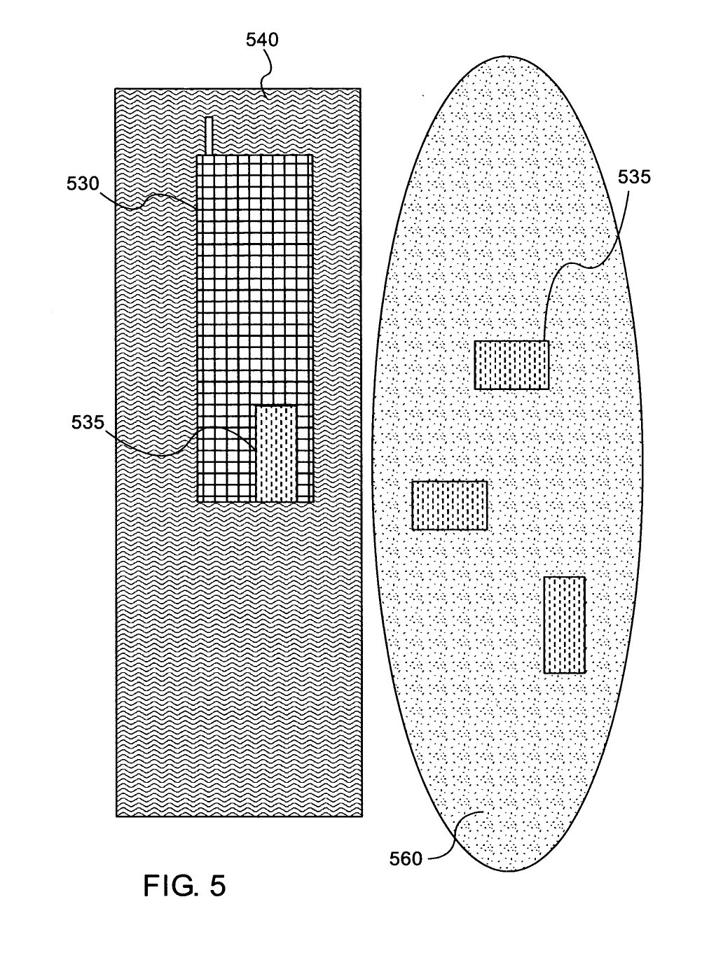

Attention is now turned to FIG. 5, which is a schematic view of a this preferred embodiment in action. In this embodiment, amphibious vehicles (535) leave vessel (530) and reach multiple points in the land region (560) for distribution of desalinated water produced from the sea (540). The advantage of using amphibious vehicles includes the ability to bring desalinated water and potentially electrical power to the points of need and not merely rely on available pipes or the like.

### Second Embodiment

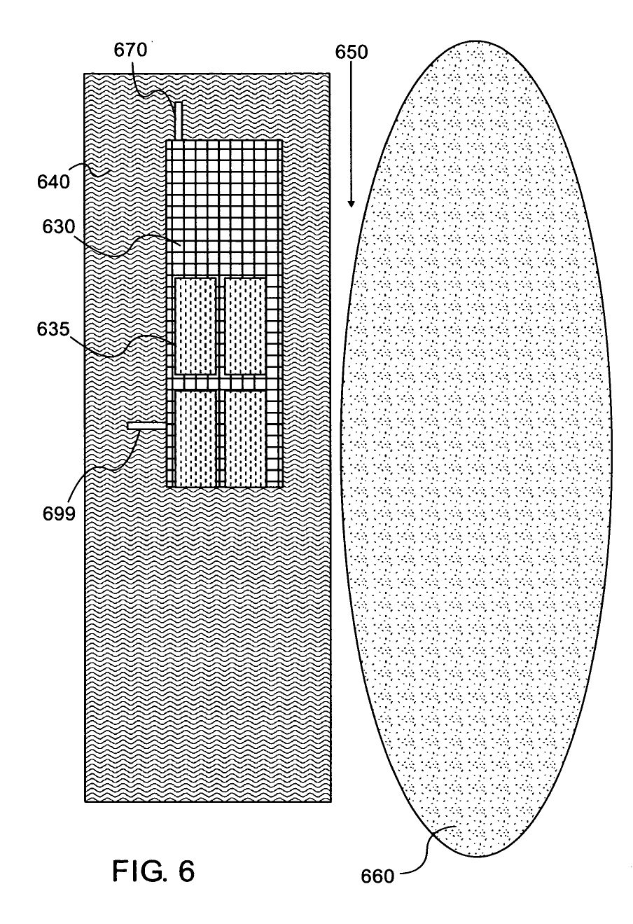

In FIG. 6, an alternative preferred embodiment of the present invention is presented. Vessel (630) is a fixed structure in the sea (640) and has an inlet pipe (670) for seawater. The vessel (630) can produce both desalinated water for human consumption and concentrated brine for its own electricity production. As shown, vessel (630) includes a plurality of amphibious vehicles (635) for both production and in-land distribution of desalinated water and electricity. A runoff pipe (699) removes remaining concentrated brine from the vessel (630) and returns it to the sea (640) at a distance of 1 kilometer from the shore (650) of a land region (660).

### Third Embodiment

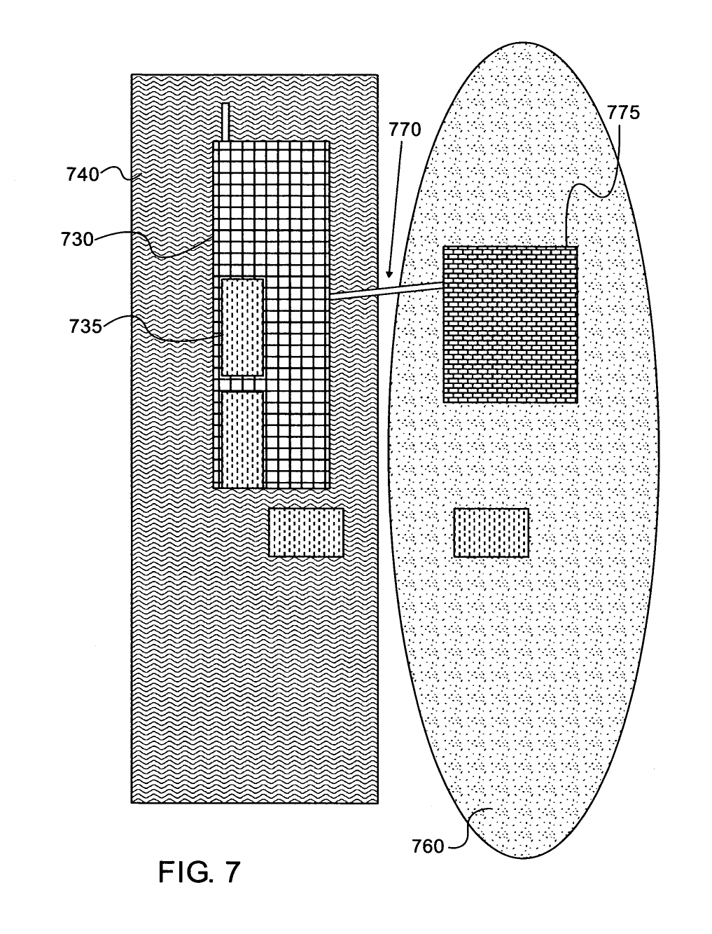

The embodiment shown schematically in FIG. 7 shows a vessel (730) at sea (740) that delivers desalinated water to land region (760) via a plurality of amphibious vehicles (735). Additionally, the vessel (730) can deliver electricity via a transmission line (770) to a land-based power grid (775). After many natural disasters, such as Hurricane Katrina in New Orleans, drinking water and electricity are two of the most pressing needs of those affected. The vessel (730) is outfitted with a plurality of amphibious vehicles (735) for rapid and location-specific delivery of potable water as well as thousand of ready-to-eat meals and temporary emergency shelters and blankets that the vessel (730) carries.

A portion of the waste brine is used by vessel (730) for production of electricity as per the Kanzius RF processes. Solar power is used to generate electricity aboard the vessel. Solar-based electricity is used to generate RF signal which, when directed towards a portion of the waste brine, causes the generation of intense heat. This heat is used to convert water to steam and drive electricity production. Said electricity may be delivered to a land region (760) either by amphibious vehicles (735) and/or the transmission line.

As to more details on the working of the RF system, the information below is adapted from Kanzius (U.S. patent application Ser. No. 11/050,478):

An RF system for inducing hyperthermia in a target (salt water in this case) comprises an RF transmitter in circuit communication with a transmission head and an RF receiver in circuit communication with a reception head. “Circuit communication” as used herein is used to indicate a communicative relationship between devices. Direct electrical, optical, and electromagnetic connections and indirect electrical, optical, and electromagnetic connections are examples of circuit communication. Two devices are in circuit communication if a signal from one is received by the other, regardless of whether the signal is modified by some other device. For example, two devices separated by one or more of the following—transformers, optoisolators, digital or analog buffers, analog integrators, other electronic circuitry, fiber optic transceivers, or even satellites—are in circuit, communication if a signal from one reaches the other, even though the signal is modified by the intermediate device(s). As a final example, two devices not directly connected to each other (e.g. keyboard and memory), but both capable of interfacing with a third device, (e.g., a CPU), are in circuit communication.

In exemplary system the RF transmitter generates an RF signal at a frequency for transmission via the transmission head. Optionally, the RF transmitter has controls for adjusting the frequency and/or power of the generated RF signal and/or may have a mode in which an RF signal at a predetermined frequency and power are transmitted via transmission head. In addition, optionally, the RF transmitter provides an RF signal with variable amplitudes, pulsed amplitudes, multiple frequencies, etc.

The RF receiver is in circuit communication with the reception head. The RF receiver is tuned so that at least a portion of the reception head is resonant at the frequency of the RF signal transmitted via the transmission head. As a result, the reception head receives the RF signal that is transmitted via the transmission head.

The transmission head and reception head are arranged proximate to and on either side of a general target area (salt water brine). General target is general location of the area to be treated. The transmission head and reception head are preferably insulated from direct contact with the general target area. Preferably, the transmission head and reception head are insulated by means of an air gap. Optional, means of insulating the transmission head and reception head from the general target area include inserting an insulating layer or material, such as, for example, Teflon® between the heads and the general target area. Other optional means include providing an insulation area on the heads, allowing the heads to be put in direct contact with the general target area. The transmission head and the reception head, described in more detail below, may include one or more plates of electrically conductive material.

The general target area (brine) absorbs energy and is warmed as the RF signal travels through the general target area. The more energy that is absorbed by an area, the higher the temperature increase in the area. Energy absorption in a target area can be increased by increasing the RF signal strength, which increases the amount of energy traveling through the general target area. Other means of increasing the energy absorption include concentrating the signal on a localized area, or specific target area, and/or enhancing the energy absorption characteristics of the target area.

One method of inducing a higher temperature in the specific target area includes using a reception head that is smaller than the transmission head. The smaller reception head picks up more energy due to the use of a high-Q resonant circuit described in more detail below. Optionally, an RF absorption enhancer is used. An RF absorption enhancer is any means or method of increasing the tendency of the specific target area to absorb more energy from the RF signal. Injecting an aqueous solution is a means for enhancing RF absorption. Aqueous solutions suitable for enhancing RF absorption include, for example, water, saline solution, aqueous solutions containing suspended particles of electrically conductive material, such as metals, e.g., iron, various combination of metals, e.g., iron and other metals, or magnetic particles. These types of RF enhancers (i.e., non-targeted “general RF enhancers”) are generally directly introduced into the target area. Other exemplary general RF enhancers are discussed below, e.g., aqueous solutions of virtually any metal sulfate (e.g., aqueous solutions of iron sulfate, copper sulfate, and/or magnesium sulfate, e.g., aqueous solutions (about 5 mg/kg of body mass), copper sulfate (about 2 mg/kg of body mass), and magnesium sulfate (about 20 mg/kg of body mass)), other solutions of virtually. any metal sulfate, injectable metal salts (e.g., gold salts), and RF absorbing particles attached to other non-targeted carriers. Preferably, these types of RF enhancers may be directly injected into the target area by means of a needle and syringe, or otherwise introduced into the patient.

Optionally, multiple frequency RF signals are used. Multiple frequency RF signals can be used to treat target areas. Multiple frequency RF signals allow the energy absorption rate and absorption rate in different locations of the target area to be more closely controlled. The multiple frequency signals can be combined into one signal, or by use of a multi-plated transmission head, or multiple transmission heads, can be directed at one or more specific regions in the target area. This is useful for treating target areas that have specific regions of various shapes, thicknesses and/or depths. Similarly, pulsed RF signals, variable frequency RF signals and other combinations or variations of the RF signals can be used to more precisely control and target the heating of the specific target areas. These and other methods of increasing RF absorption can be used independently or in any number of combinations to increase the energy absorption rate of the specific target area.

### Fourth Embodiment

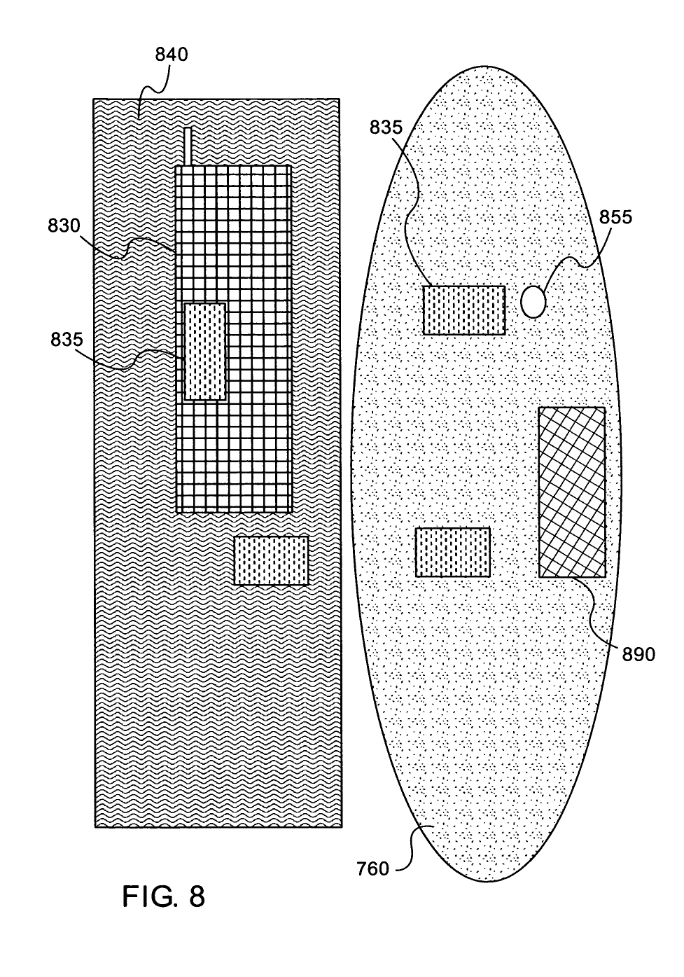

In a preferred embodiment of the present invention schematically represented in FIG. 8, desalination vessel (830) at sea (840) produces desalinated water which is shipped by amphibious vehicles (835) to a water distribution point (855) deep inland. Additionally, the amphibious vehicles (830) can transfer concentrated brine to a deep inland power plant (890). In this embodiment, a Kanzius-class electricity-producing power station (890) is not in close proximity to the site of desalination. A desalination ship (830) will always travel to a location that is in relatively close proximity to needed potable water, though the needed water may have to be shipped deep inland due to a lack of piping infrastructure, war, natural disaster or the like. Concentrated brine, like coal, on the other hand may be shipped by a dedicated amphibious vehicle over long distances to a power plant site (not shown).

### Fifth Embodiment

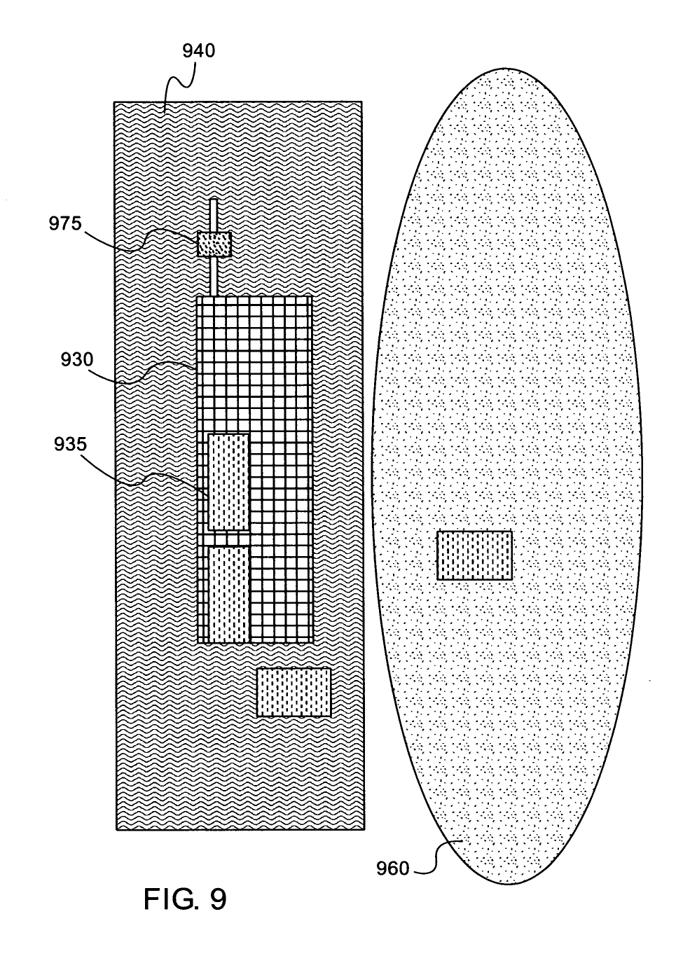

In the preferred embodiment of the instant invention schematically represented in FIG. 9, water quality is addressed before and after salination. A desalination vessel (930) has an intake pipe that includes a filter (975), said filter removing all solid and large particulate matter from the sea water (940). The filter (975) is selected with a pore-size or cutoff range to allow for effective intake of seawater (940) into the desalination vessel (930) for efficient desalination. The filter (975) is shown as a part of the pipeline (970) for convenience of visualization only. It may alternatively be associated with or integrated into the desalination vessel (930) or individual amphibious vehicles (935). Desalinated water leaving the desalination vessel (930) is taken to land (960) by amphibious vehicles (935). A water purification element (not shown, generally aboard the amphibious vehicles (935) treats desalinated water. The water purification element can kill bacteria either through treatment with UV light or chemicals. The water purification element can additionally alter the pH of the desalinated water, filter the desalinated water or add minerals or vitamins. The water purification element is generally associated with water outlets on the amphibious vehicles (935). It may alternatively be associated with the desalination vessel (930), or be integrated into an land-based water distribution system (not shown). Concentrated brine produced by desalination vessel (930) is used in part to power desalination vessel (930), with the remainder of the brine being sent back to the sea (940).

### Example 1

A seaworthy vessel is selected for desalination according to reverse osmosis. Typical principal dimensions and storage capacities of a converted vessel are as follows: Length Overall (LOA): 274 m; Breadth: 32.00 m; Depth: 24.00 m; Draft: 16.00 m. A standard bulk carrier hull form is most ideal for a floating desalination and power plant. For example: Gearless Capesize Bulk Carrier (NV Class/Main Eng: Sulzer 27000 BHP: TDW: 148,140; Draft: 15.92; Built in Japan 1986). The vessel can house a crew compliment of 22. Standard crew quarters, eating, sanitary and recreational facilities are provided. The vessel includes a large space for the storage of membrane and chemical inventory, mechanical spare parts and emergency response equipment including plastic bags for liquid transport and storage, military food rations, emergency tent shelters and blankets. Storage capacities include: Cargo Holds: 166,000 m3, Fresh Water: 450 m3, Heavy Fuel Oil: 4,600 m3; Marine Diesel Oil: Approx. 400 m3; Water Ballast: Approx. 57,000 m3; Permeate Holding Tanks: 2,000 m3. Additionally, 2,000 m3 of desalinated water may be stored onboard for quality assurance testing, onboard usage and compensation for flow fluctuations in potable water supply. The ship additionally has five amphibious vehicles, modified Army “DUCK” vehicles, designed for containing large amounts of water, for desalinating water and for pilotless operation. Camera and computer systems allow control of the amphibious vehicles from the mother vessel.

Intake System—Seawater is taken through sea chests at the bow of the vessel and passes through a filter. The seawater supply pumps elevate the pressure of the seawater sufficiently to pass it through the pre-filtration treatment process. It uses the same piping material as the Pipe for Water Transmission System (described below). Seawater thus taken in is next filtered and then desalinated by reverse osmosis.

Pre-Filtration Treatment System—Reverse osmosis (RO) membranes are at the heart of the desalination process. RO membranes are able to prevent the passage of very small ions such as those of salts found in seawater. But they are highly susceptible to fouling by the organics and other colloidal matter commonly found in seawater. In fact the most critical step in the success of an RO system is usually the effectiveness of its pretreatment system. Pre-treatment of the feed water is needed in order to extend membrane life and optimize membrane performance. Advanced UF membranes use compact bundles of thousands of hollow fine fibers to remove particles, bacteria and viruses greater than 0,01 μm in a single step to produce high quality water. These cutting edge UF membranes feature a highly compact design, resulting in a very small footprint. This has major advantages in a desalination vessel where space is very scarce and expensive. The UF have to be regularly back-washed with filtered seawater and scour air from the bottom to the top, the effluent being discharged into the sea. The swaying of the ship, caused by heavy seas or stormy winds must not influence the process. Using pressure UF filters instead of open filters, can minimize swaying influences. Other pretreatment steps are considered: dosage of acid to remove bicarbonate ions followed by aeration and to remove carbon dioxide; cartridge filtering of particles obtained by oxidation of metal ions, de-chlorinating using sodium-bi-sulphite to remove residual free chlorine, active carbon to remove dissolved organic materials and chlorine compounds. Different antiscalants are used in order to prevent precipitation of least soluble salts. Some relatively small molecules like carbon dioxide, hydrogen sulphide, silica and boric acid may permeate and pollute the product quality. A feed water dump valve is positioned downstream of the monitoring equipment to divert the pretreated feed water to the sea if one of the measured parameters does not comply with operating guidelines.

Reverse Osmosis System—The feed water is pumped through the membranes with sufficient pressure and 40% of the feed water being converted into potable desalinated water with the rest as concentrated brine. Desalinated water is treated (see below) and shipped via pipeline to a municipal water system. The concentrated brine passes through energy recovery turbines and then may be partially transferred to shore via pipe, or amphibious vehicles with the balance being discharged overboard. These brine-based energy recovery and fuel generation efforts significantly reduce the overall energy consumption of the desalination process. Concentrated brine may alternatively be shipped directly to a power plant or off-loaded to a second vessel, said second vessel taking the concentrated brine to shore. Chemical cleaning of the RO racks is performed regularly in order to reestablish the initial plant performance. Given its considerable size and available space, the vessel can deploy multiple iterations of reverse osmosis plants such as those manufactured by Siemens (Vantage H series) and General Electrics (SWRO series). As described, the present invention may employ reverse osmosis or any other method of desalination. Prior to delivery of desalinated water to a municipal water system, the water is treated.

Post-RO Treatment System—Disinfectant and lime are added downstream of the vessel desalinated water tank for disinfections, pH adjustment and passivation. A water purification element will also process the desalinated water using Ultraviolet lighting (i.e. TrojanUV3000 Plus—www.trojanUV.com) After UV disinfection, desalinated water is potable water and may thus be sent by pipeline to shore.

Pipe for Water Transmission System—The vessel will deliver water that fully meets the WHO drinking water standards. Full details are available at: http:/www.who.int/water_sanitation_health/dwq/dwq3rev/en/index.html. The vessel will be designed to deliver 150,000 m3/day permeate. The vessel will connect to beach by pipeline, partly in polyethylene (PE) partly in rubber and of suitable dimension. This pipeline will be towed air-filled to site by vessel and deployed on the sea bed. At the beach the pipe will be connected to a holding tank or a local distribution system and water mains or, in case absent (i.e. emergent need situation), a simple distribution cauldron may be deployed. For example: PE OD 1,000 mm high density polyethylene (HDPE) pipes for marine a construction (i.e those manufactured by Pipelife Norge AS—www.pipelife.com), with flexible rubber hoses at either end and pullhead, flanges, valves, ship connection units (i.e those manufactured by Plastek), anchors and a permanent distribution tank at beach (i.e. corrugated tank by BH Tank—www.bhtank.com) or a temporary distribution tank for emergencies (Alligator L Tank—www.albersalligator.com/getme.php?site_ID=222&pageid=2391).

Pipe for Brine Water Transmission System—The vessel can also deliver 11,250 m3/day of concentrated brine to shore via a second pipeline.

### Example 2

A vessel containing four amphibious vehicles departs for Africa. Each amphibious vehicle can take in sea water, desalinate it and deliver waste brine to the mother vessel. The mother vessel includes PV solar collectors for generating electrical energy. Electrical energy is used to generate RF signal, the RF signal being directed to a portion of the waste brine. The waste brine, in response to RF signals, generates a flame of intense heat. The flame is used to heat water, generate steam and ultimately deliver electricity to the mother vessel and amphibious vehicles. The amphibious vehicles are shipped out, loaded with potable water and batteries charged with electricity. The amphibious vehicles are piloted by crew of the mother vessel and are sent 20 miles inland to a predetermined set of GPS coordinates. There, medical and military staff receive the amphibious vehicles for distribution of water and use of electricity stored in the batteries. When the water and electricity have been used, the amphibious vehicles are piloted back to the mother vessel, where they dock and again perform desalination of sea water.

### Example 3

A desalination vessel is supplied. The vessel has the following non-limiting features:

1. Intake System

2. Pre-Filtration System

3. Desalination System (reverse osmosis)

4. Post-RO Treatment System

5. Desalinated Water Transmission System to land

6. Brine Transmission System to land and sea

7. Pumps

8. On-Board power plant which may include solar and/or wind elements

9. Holding tanks and other storage holds

10. On-Board crew quarters, mess hall, kitchen, entertainment areas

11. Engine

12. Helipad

13. Fleet of amphibious vehicles

The vessel is available for UN-initiated disaster relief response. As the ship can send amphibious vehicles with potable water and electric power, the vessel is ideal for rapid-response to sudden devastation such as that which occurs after hurricanes, tsunamis and the like. The advantage of the present invention is the lack of reliance on piping and local infrastructure.

The present invention has been described with a certain degree of particularity, however those versed in the art will readily appreciate that various modifications and alterations may be carried out without departing from the spirit and scope of the following claims. Therefore, the embodiments and examples described here are in no means intended to limit the scope or spirit of the methodology and associated devices related to the present invention. The desalination system described herewith is unique in that it is the first to invoke a commercial use of concentrated brine, the normal waste byproduct of desalination. By providing highly concentrated brine for vessel power production or other uses, the present invention makes desalination an economically-viable method of drinking water production and delivery. It will be obvious to those versed in the art that the present invention could additionally include a transfer pipe from vessel to shore, in addition to the desalinating amphibious delivery vehicles which both make and deliver water site-specifically to areas of need.

1. A system for providing desalinated water to an inland location including:
a vessel, said vessel having an intake pipe and being capable of producing desalinated water via a plurality of amphibious delivery vehicles wherein a portion of the waste concentrated brine is used to generate electrical power aboard the vessel.

2. The system according to claim 1, wherein the vessel is a ship.

3. The system according to claim 1, wherein the vessel is a fixed offshore structure.

4. The system according to claim 1, wherein at least five percent (5%) of the concentrated brine produced on the vessel is used to power the vessel, with the rest of the brine being returned to the ocean by any means.

5. The system according to claim 1, wherein the concentrated brine is used, at least in part, to generate electricity, a portion of which may be sent to shore via a transmission line.

6. The system according to claim 1, wherein said amphibious delivery vehicles may bring drinking water and electricity to one or a plurality of inland locations.

7. The system according to claim 1, wherein the desalinated water is delivered to a plurality of distinct inland locations by a plurality of amphibious delivery vehicles.

8. The system according to claim 1, wherein the amphibious delivery vehicles can be repeatedly attached and detached from the desalination mother vessel.

9. The system according to claim 1, wherein the vessel may transfer electricity to shore via batteries associated with the amphibious delivery vehicles.

10. The system according to claim 1, wherein the amphibious delivery vehicles may be robotic without any personnel.

11. A method for producing desalinated water and concentrated brine and shipping the water to shore, including the steps:
providing a vessel, the vessel being capable of producing desalinated water and concentrated brine;
transferring desalinated water directly to point of use with amphibious delivery vehicles;
using a portion of the concentrated brine to generate electricity on the vessel;
sending the electricity to shore either through a transmission line or via batteries on said amphibious delivery vehicles; and,
returning remaining concentrated brine to the sea.

12. The method according to claim 11, wherein the vessel, is a ship.

13. The method according to claim 11, wherein said desalinated water produced by the vessel is further purified on said amphibious delivery vehicles prior to delivery of water to an inland location.

14. The method according to claim 11, wherein electrical energy is produced on said vessel by converting thermal solar electricity to an RF signal, the RF signal being applied to the concentrated brine.

15. The method according to claim 14, wherein the application of the RF signal to concentrated brine leads to production of intense heat, the heat being used to heat water to high-temperature steam for powering of an electricity-generating turbine.

16. The method according to claim 15, wherein the electricity produced by applying an RF signal to the concentrated brine is shipped via a transmission line realized as a cable to a land-based electrical grid.

17. A system for producing electrical energy from desalination byproduct concentrated brine, including:
a vessel, the vessel being capable of producing desalinated water and concentrated brine; and,
a at least one amphibious delivery vehicle for transferring said desalinated water and said concentrated brine to a shore-based holding element.

18. The system according to claim 17, wherein said vessel is a fixed offshore structure.

19. The system according to claim 17, wherein the fixed offshore structure is in close proximity to a power plant.

20. The system according to claim 17, wherein the system includes a source for RF signal.
